(19) United States
(12) Patent Application Publication
(10) Pub. No.: US 2010/0243761 A1
(43) Pub. Date: Sep. 30, 2010

(54) METHOD AND DEVICE FOR PREVENTING LIQUID DISPENSATION FROM AN AEROSOL SPRAY CAN

(76) Inventors: Anatoly Gosis, Palatine, IL (US); Yury Shkolnikov, Glenview, IL (US); Zinovy Royzen, Seattle, WA (US); David Boyoon, Canyon, TX (US); Steven Owanda Cook, Vega, TX (US); Douglas Ngai, Amerillo, TX (US)

Correspondence Address: Klintworth & Rozenblat IP LLC, 300 West Adams St., Suite 423, Chicago, IL, 60606, US

(21) Appl. No.: 12/414,844

(22) Filed: Mar. 31, 2009

(51) Int. Cl. A62C 13/62

(52) U.S. Cl. 239/372

(57) ABSTRACT

An aerosol spray can is provided. The aerosol spray can includes but is not limited to a housing, an initial amount of a chemical within the housing in both liquid and gaseous states, a valve assembly attached to the housing, an extension tube connected with the valve assembly, and a flotation device connected with the extension tube. The chemical in a liquid state forms a top surface above which there is the chemical in a gaseous state. The extension tube is connected with the valve assembly at a first end and extends into the housing at a second end. The second end of the extension tube forms an opening. The flotation device floats on the chemical in a liquid state.

### FIELD OF THE INVENTION

The present invention relates to aerosol spray cans. More specifically, it relates to a method and device for preventing liquid dispensation from an aerosol spray can.

### BACKGROUND

Aerosol spray cans house and emit chemicals for a variety of purposes. Usually the chemicals are stored within the aerosol spray can as a vapor of a liquid with a boiling point slightly lower than room temperature. This means that inside the aerosol spray can, the vapor can exist in equilibrium with its bulk liquid at a pressure that is higher than atmospheric pressure and able to expel the payload. As the chemicals are dispensed from the aerosol spray can, the chemicals expand from a liquid into a gaseous state as they go from a pressurized liquid state within the aerosol spray can to a non-pressurized gaseous state outside the aerosol spray can. Any dispensed chemicals that were in a gaseous state while housed in the aerosol spray can are immediately replaced by evaporating liquid within the aerosol spray can.

Although the chemicals are typically dispensed from the aerosol spray can in a gaseous state, sometimes the chemicals may be dispensed in a liquid state. For example, if the aerosol spray can is shaken or tilted, it is possible to trap some chemicals in a liquid state within an extension tube that resides in the aerosol spray can. Once inside the extension tube, the chemicals in a liquid state may be dispensed from the aerosol spray can if the user then depresses a trigger or button affixed to the aerosol spray can. Dispensing the chemicals from the aerosol spray can in a liquid state, instead of gaseous state, can not only be wasteful but dangerous as well.

Some aerosol spray cans are used as dust blowing devices. Presently, dust blowing devices generally consist of a pressurized gas source for their stored chemicals, a valve and a nozzle for directing the gas flow. The pressurized gas is used to blow dust or other particles from the surface to be cleaned e.g. floppy disks for computers, lenses for microscopes, cameras and other optical instruments, assembled microchips, consumer electronic devices and other small or hard-to-reach places.

These dust blowing devices typically house chemicals such as chlorofluorocarbons, e.g. Freon (Freon is a trade name for a particular chlorofluorocarbon manufactured by DuPont), or Freon-22, in a pressurized state within the aerosol spray can. When these liquefied chlorofluorocarbons are released from the container, they change to gas and exit the container under pressure. A jet of chlorofluorocarbon gas is thus used to blow dust from the surface to be cleaned. However, in order to ensure that only chlorofluorocarbon gas is released from the container, the container must be maintained in a substantially upright position.

If the can is inverted, liquefied chlorofluorocarbon may escape from the container. For the typical consumer, it is desirable to avoid this. Liquefied chlorofluorocarbons are extremely cold and can cause frostbite if they contact the user's hand. Also, allowing liquefied chlorofluorocarbons to escape from the container results in wasted chlorofluorocarbons. Some dust blowing devices use liquefied hydrofluorocarbons instead of liquefied chlorofluorocarbons. In addition to the above mentioned issues with releasing liquefied chlorofluorocarbons, releasing liquefied hydrofluorocarbons pose an additional danger in that they are flammable as well.

Unfortunately, it is difficult to maintain aerosol spray cans, such as dust blowing devices, in a substantially upright position when directing them on hard-to-reach surfaces, such as in consumer electronic devices. As a result, it would be desirable to have a mechanism within the aerosol spray can which prevents or minimizes liquid dispensation from an aerosol spray can.

### SUMMARY

In one aspect, an aerosol spray can is provided. The aerosol spray can includes but is not limited to a housing forming a storage chamber, an initial amount of a chemical within the storage chamber, a valve assembly attached to the housing, an extension tube connected with the valve assembly, and a flotation device connected with the extension tube. The initial amount of a chemical within the storage chamber is in both liquid and gaseous states. The chemical in a liquid state forms a top surface above which there is the chemical in a gaseous state. The valve assembly includes a stem forming a central passage through which the chemical dispenses from the storage chamber. The extension tube is connected with the valve assembly at a first end and extends into the storage chamber at a second end. The second end of the extension tube forms an opening through which the chemical enters the extension tube. The flotation device is connected with the extension tube. An average density of the flotation device is equal to or less than an average density of the chemical in a liquid state.

In one aspect, an aerosol spray can is provided. The aerosol spray can includes but is not limited to a housing, an initial amount of a chemical within the housing in both liquid and gaseous states, a valve assembly attached to the housing, an extension tube connected with the valve assembly, and a flotation device connected with the extension tube. The chemical in a liquid state forms a top surface above which there is the chemical in a gaseous state. The extension tube is connected with the valve assembly at a first end and extends into the housing at a second end. The second end of the extension tube forms an opening. The flotation device floats on the chemical in a liquid state.

In one aspect, an aerosol spray can is provided. The aerosol spray can includes but is not limited to a housing, an initial amount of a chemical within the housing, a valve assembly attached to the housing, an extension tube connected with the valve assembly, and a flotation device connected with the extension tube. At least a portion of the chemical is in a liquid state. The portion of the chemical in a liquid state forms a top surface above which there is a gaseous chemical. The valve assembly prevents any chemical from exiting the housing unless the valve assembly is activated. The extension tube is connected with the valve assembly at a first end and extends into the housing at a second end. The second end of the extension tube forms an opening. Chemical exists the housing through the opening. The flotation device floats on the portion of the chemical in a liquid state.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a front perspective view of an aerosol spray can, in accordance with one embodiment of the present invention.

FIG. 2 depicts an enlarged cross section view of the aerosol spray can of FIG. 1 in an upright position along line 1-1, in accordance with one embodiment of the present invention.

FIG. 3 depicts a cross section view of the aerosol spray can of FIG. 1 in an upright position along line 1-1, in accordance with one embodiment of the present invention.

FIG. 4 depicts a cross section view of the aerosol spray can of FIG. 1 in an upside down position along line 1-1, in accordance with one embodiment of the present invention.

FIG. 5 depicts a cross section view of the aerosol spray can of FIG. 1 in a sideways position along line 1-1, in accordance with one embodiment of the present invention.

FIG. 6 depicts an enlarged cross section view of a portion of the aerosol spray can of FIG. 1 in a depressed state along line 1-1, in accordance with one embodiment of the present invention.

### DETAILED DESCRIPTION

In one embodiment, by connecting a flotation device with a second end of the extension tube, the second end of the extension tube is able remains a distance away from a top surface of an initial amount of chemical in the aerosol spray can regardless of the position of the aerosol spray can. As a result, liquefied chemical can be prevented from exiting the aerosol spray can.

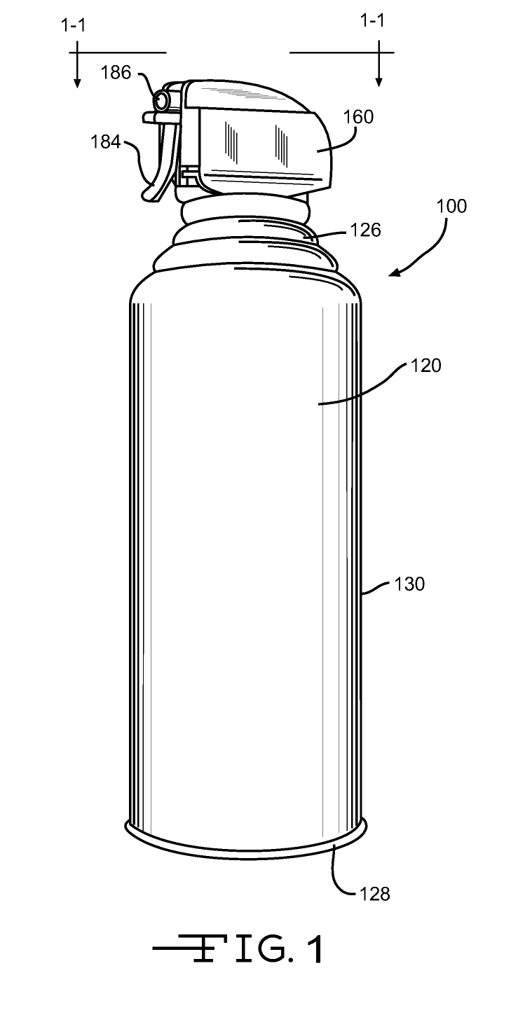

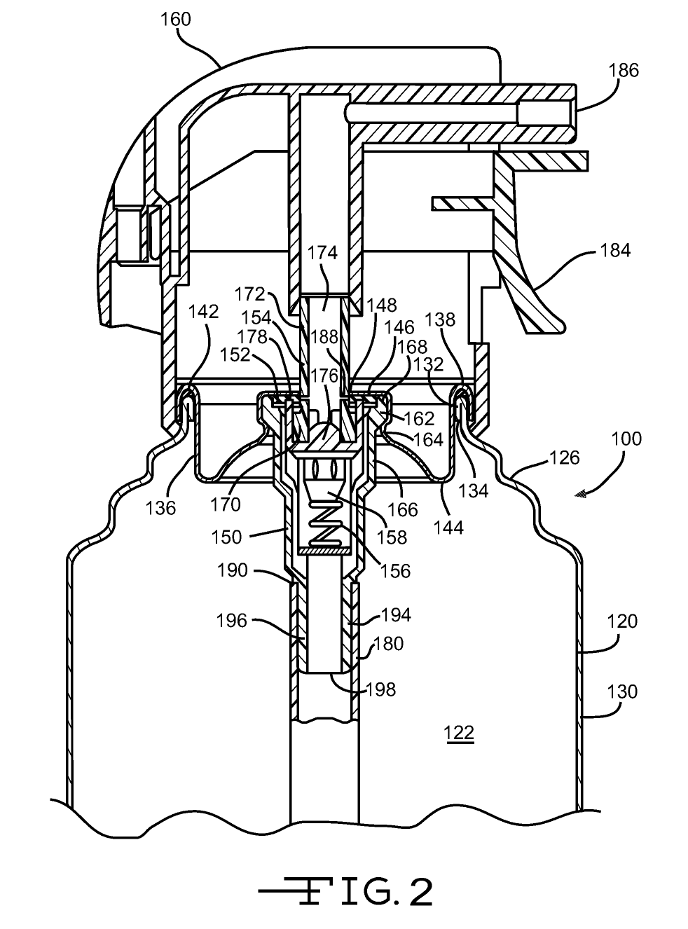

Referring now to FIGS. 1 and 2, there is shown an aerosol spray can 100 having a housing 120, a valve assembly 140 attached to the housing 120, an actuator 160 connected with the valve assembly 140, and an extension tube 180 connected with the valve assembly 140. Aerosol spray can 100 stores a chemical 124 which may be used for a variety of purposes, such as cleaning, dusting, lubricating, and adhesion. In one embodiment, the chemical 124 is stored within the aerosol spray can 100 as a vapor of a liquid with a boiling point slightly lower than room temperature. As a result, inside the aerosol spray can 100, chemical 124 may be in both a gaseous state and a liquid state, and the chemical 124 that is in a gaseous state can exist in equilibrium with the chemical 124 which is in a liquid state at a pressure that is higher than atmospheric pressure and able to expel the chemical 124. Preferably, at least a portion 104 of chemical 124 is in a pressurized, liquid state, which transitions to a gaseous state upon exiting the aerosol spray can 100. More preferably, at least a portion 104 of chemical 124 is in a pressurized, liquid state, and at least another portion 105 of chemical 124 is in a pressurized, gaseous state, within aerosol spray can 100. Upon exiting the aerosol spray can 100 in gaseous form, chemical 124 may be used for a variety of purposes, such as to blow dust or other particles from a surface to be cleaned e.g. floppy disks for computers, lenses for microscopes, cameras and other optical instruments, assembled microchips, consumer electronic devices and other small or hard-to-reach places.

Chemical 124 may comprise, but is not limited to, a household cleaning chemical such as ammonia, bleach, alkalies, acids, detergents, abrasives, sanitizers, and spirit solvents; a lubricant such as petroleum based products, mineral oils, vegetable oils, or synthetic liquids such as hydrogenated polyolefins, esters, silicone, fluorocarbons; an adhesive such as natural adhesives made from inorganic mineral sources or biological sources, synthetic adhesives including elastomers, thermoplastic, and thermosetting adhesives, and drying adhesives having polymers dissolved in a solvent.

Preferably, within aerosol spray can 100, chemical 124 resides in a compressed liquid state, that is, a state in which the chemical 124 is compressed to a pressure which is greater than atmospheric pressure, or greater than about 110 kPA, so that the chemical 124 is changed from a gaseous to a liquid state. Preferably, chemical 124 is compressed to a liquid state under a pressure of at least 110 kPA at a temperature of at least zero degrees Celsius, and converts back to a gaseous state upon exiting aerosol spray can 100 and reverting back to atmospheric pressure, or reverting back to a pressure of less than 200 kPA. In one embodiment, chemical 124 comprises a chlorofluorocarbon such as Freon or Freon-22 (Freon is a trade name for a particular chloroflourocarbon manufactured by DuPont), hydrofluorocarbons such as HFC-152a, nitrogen, or carbon dioxide. However, one having skill in the art will appreciate that chemical 124 is not limited to these illustrative chemicals and may comprise other chemicals. Preferably, chemical 124 consists generally of HFC-152.

Housing 120 forms a storage chamber 122 for storing chemical 124. Preferably, storage chamber 122 stores chemical 124 in a pressurized state so that chemical 124 resides in both a gaseous and liquid state within the storage chamber 122. In one embodiment, housing 120 is a conventional can, such as a metal can suitable for containing a pressurized chemical in a gaseous and liquid state. Housing 120 includes a slopping upper wall 126, opposed to a bottom cover 128 and a sidewall 130, formed in between and connecting the sloping upper wall 126 with the bottom cover 128. The sloping upper wall 126 forms a curved lip 132 defining an opening 134.

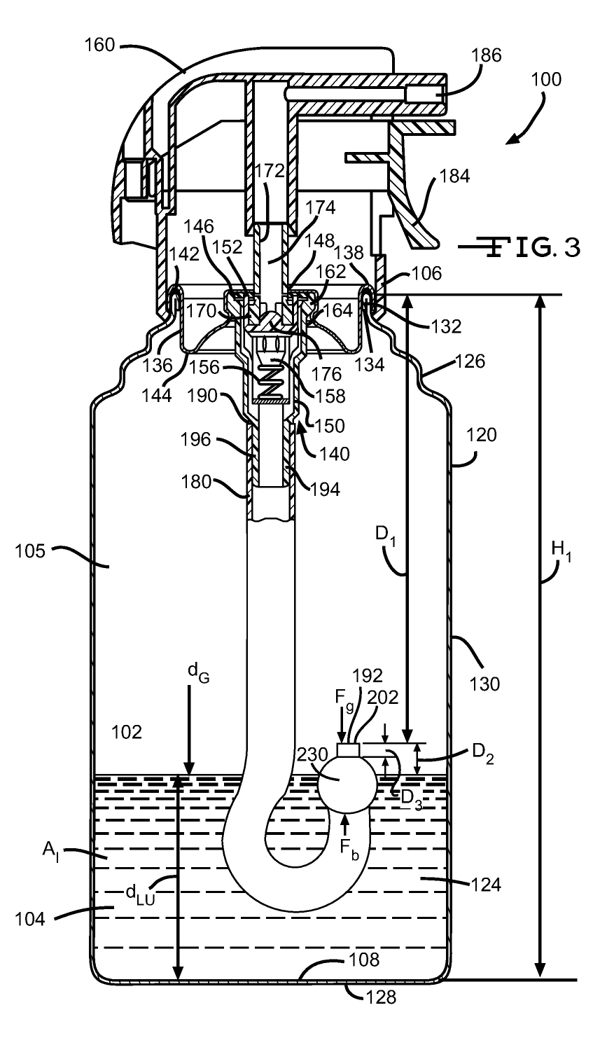

Referring to FIGS. 2 and 3, housing 120 also includes a mounting cup 136 connected with the sloping upper wall 126 and covering opening 134. The periphery of mounting cup 136 forms a curled portion 138 which mates with curved lip 132. A gasket 142, preferably made of foam, is located on an inner periphery of the curled portion 138. Gasket 142, and any gasket discussed herein, is preferably formed from a flexible material, such as polymer, foam, or rubber. Gasket 142 aids in sealing the curled portion 138 of the mounting cup 136 to the curved lip 132 of the upper wall 126. Mounting cup 136 forms an annular depression 144 and a central upward pedestal 146 forming in its upper end a central opening 148.

Valve assembly 140 is attached to the housing 120 through central opening 148. Preferably, a first portion of the valve assembly 140 resides in the storage chamber 122 and a second portion of the valve assembly resides outside of the housing 120 and storage chamber 122. The valve assembly 140 prevents any amount of chemical 124 from exiting the housing 120 unless the valve assembly 140 is activated. Valve assembly 140 may be activated by depressing a stem 172 of valve assembly, as described herein, or by activating the actuator 160. Upon activation, the valve assembly 140 creates a passageway for chemical 124 residing in storage chamber 122 to exit the housing 120. Valve assembly 140 includes a valve body 150, a gasket 152, a valve plunger 154, a spring 156, and a spring cup 158.

The valve body 150 is formed at its upper end with spaced outward projections 162 under which the pedestal 146 is inwardly crimped at 164 to fixedly mount the valve body 150 to the mounting cup 136. Sidewalls 166 of the valve body 150 fall short of an upper end 168 of projections 162 and present an annular support for gasket 152 which is sealingly disposed between the upper end 168 of the projections 162 and an inside surface of the pedestal 146. Gasket 152 is preferably formed of rubber. Valve plunger 154 is disposed with its head 170 inside the valve body 150.

The upper end of the valve plunger 154 is in the form of a tubular stem 172 which extends up through the gasket 152 and through the central opening 148 in the mounting cup 136. The stem 172 forms a central passage 174 through which the chemical 124 is dispensed from the storage chamber 122. Stem 172 extends from outside the housing 120, through the central opening 148, and into the housing 120. Valve plunger 154 also includes a stem support 176 located in the housing 120 and surrounding head 170 of the stem 172. Preferably, the upper end of the stem support 176 is provided with an annular seat 178 which is biased against and engages the gasket 152, via spring 156, to provide further sealing.

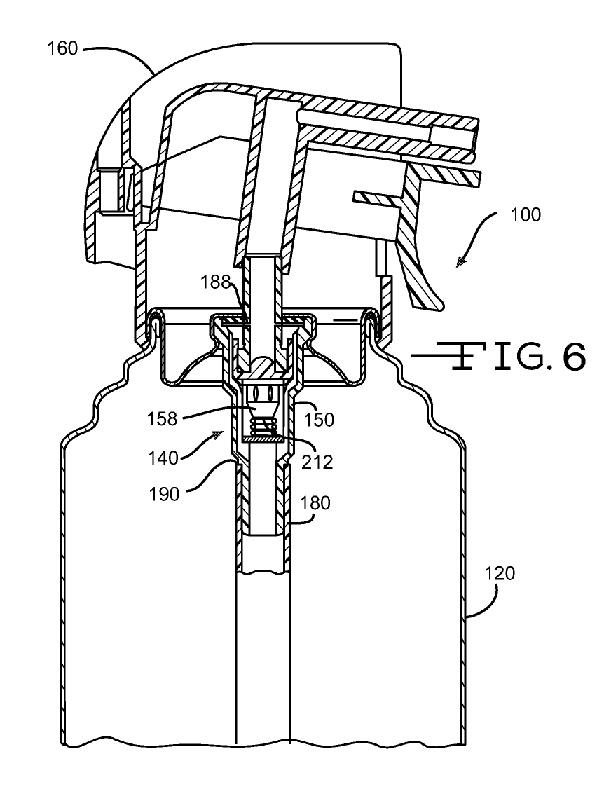

The stem 172 is movable from a normal position shown in FIG. 2, where the stem support 176 is biased against and engages the gasket 152 and chemical 124 is prevented from entering central passage 174, to a depressed position shown in FIG. 6, where the stem support 176 does not engage the gasket 152 and chemical 124 is allowed to flow into central passage 174, via an actuator 160. Actuator 160 is connected with the valve assembly 140. The actuator 160 may be either a button (not shown) or trigger 184. Preferably, a discharge orifice 186 is in communication with the central passage 174 in the stem 172, in order to dispense chemical 124 in a spray from the aerosol spray can 100. In the normal position, the central passage 174 is sealed from the extension tube 180 and in the depressed position the central passage 174 is connected with the extension tube 180, allowing fluid, such as chemical 124, to travel between the extension tube 180 and the central passage 174.

Preferably, radial channels 188 are formed in the tubular stem 172. The radial channels 188 are in alignment with the gasket 152 when the stem 172 is in a normal position, that is, when the actuator 160 is not engaged. By aligning the radial channels 188 with the gasket 152 in the normal position, chemical 124 is prevented from being dispensed from the storage chamber 122. When engaged, the actuator 160 causes the stem 172 to move to the depressed position, downwards towards the opening 148, dispensing chemical 124 from the storage chamber 122 through central passage 174, and out discharge orifice 186.

The extension tube 180 is connected with the valve assembly 140 at a first end 190 and extends further into the storage chamber 122 at a second end 192, opposed to the first end 190. Preferably, the extension tube 180 is snugly telescoped over a tailpiece 194 which is integrally formed with a bottom wall 196 of the valve body 150. The tailpiece 194 forms an opening 198 over which the first end 190 of the extension tube 180 is fit. Preferably, the extension tube 180 is made of a relatively flexible, deformable material, such as rubber, polymers such as polyethylene, or silicone. The extension tube 180 extends a distance D₁ into the storage chamber 122, where D₁ is the distance from an upper surface of the storage chamber 122 to the second end 192 of the extension tube 180. The second end 192 of the extension tube 180 forms an opening 202 through which chemical 124 enters the extension tube 180.

In one embodiment, no more than an initial amount A_{I} of chemical 124 is stored within the storage chamber 122 in a liquefied form. As a result, there is also no more than the initial amount A_{I} of the liquefied portion 104 of chemical 124. The initial amount A_{I} of chemical 124 is the maximum amount of chemical 124 which is placed into the storage chamber 122 upon assembling the aerosol spray can 100. No more than the initial amount A_{I} of chemical 124 is ever placed within the aerosol spray can 100. The liquefied portion 104 of chemical 124 forms a top surface 102. The top surface 102 forms a generally planar surface which is generally perpendicular to the direction of gravity d_{G}, as illustrated by the arrows labeled d_{G}, within ±5 degrees.

Referring to FIGS. 3, 4, and 5, in one embodiment, a flotation device 230 is connected with the extension tube 180. Preferably, the floatation device 230 surrounds the extension tube 180, and more preferably, the floatation device 230 surrounds the second end 192 of the extension tube 180. In one embodiment, the floatation device 230 is located a distance D₃ from the second end 192. Preferably, D₃ is at or within five centimeters from the second end 192 of the extension tube 180. The flotation device 230 floats on the liquefied portion 104 of the chemical 124, and as a result, maintains the opening 202 of the extension tube 180 above the top surface 102 of the liquefied portion 104, and preferably, away from the liquefied portion 104. In one embodiment, the flotation device 230 maintains the second end 192 of the extension tube 180 is a distance away from the top surface 102 of the liquefied portion 104.

Preferably, an average density of the flotation device 230 is equal to or less than an average density of the liquefied portion 104 of the chemical 124. The average density of the floatation device 230 is calculated by taking the mass of the floatation device 230 and dividing it by the volume of the floatation device 230. The average density of the liquefied portion 104 is calculated by taking a mass of a set volume of the liquefied portion 104 and dividing it by the set volume of the liquefied portion 104.

By having the average density of the flotation device 230 as equal to or less than an average density of the liquefied portion 104, the flotation device 230 is prevented from sinking into the liquefied portion 104, and preferably, floats on the liquefied portion 104. By having the floatation device 230 float on the liquefied portion 104, the second end 192 of the extension tube 180 remains a distance D₂ away from the top surface 102 of liquefied portion 104 of chemical 124, regardless of the position of the aerosol spray can 100. In this manner, no matter what position the aerosol spray can 100 is in, the second end 192 is never in contact with the liquefied portion 104 of chemical 124. As a result, it is possible to reduce the amount of the liquefied portion 104 of chemical 124 which enters the extension tube 180, and eventually exits from the aerosol spray can 100.

Referring to FIG. 3, in one embodiment, the extension tube 180 extends a distance D₁ into the storage chamber 122, where the distance D₁ is from a top surface 106 of the storage chamber 122 to the second end 192 of the extension tube 180, and the height H₁ of the storage chamber 122 is measured from the top surface 106 of the storage chamber 122 to a bottom surface 108 of the storage chamber 122. The liquefied portion 104 of chemical 124 when the storage chamber 122 is in an upright position, a position in which the aerosol spray can 100 is generally parallel to and in the direction of gravity within ±5 degrees, has a depth of d_{LU}, as measured from the top surface 102 to the bottom surface 108. The flotation device 230 is connected to the extension tube 180 and floats on the liquefied portion 104 when in an upright position, helping insure that the second end 192 of the extension tube 180 remains a distance D₂ away from the top surface 102 of the liquefied portion 104 of chemical 124.

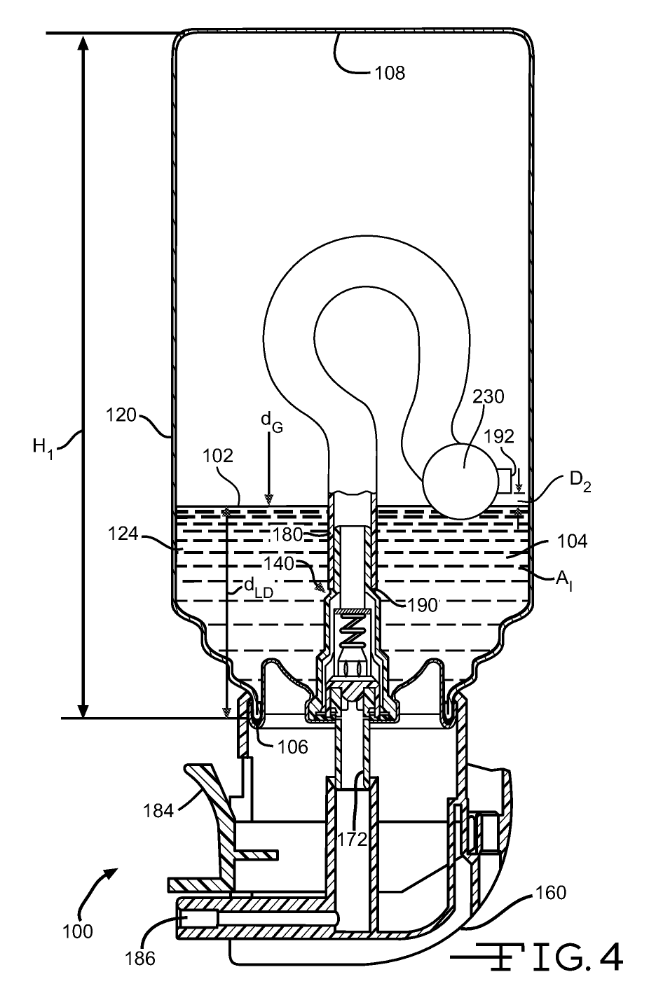

Referring to FIG. 4, in one embodiment, the extension tube 180 extends into the storage chamber 122, and the liquefied portion 104 of chemical 124 when the storage chamber 122 is in an upside down position, a position in which the aerosol spray can 100 is generally parallel to and in the opposite direction of gravity within ±5 degrees, has a depth of d_{LD}, as measured from the top surface 102 to the top surface 106. The flotation device 230 is connected to the extension tube 180 and floats on the liquefied portion 104 when in an upside down position, helping insure that the second end 192 of the extension tube 180 remains a distance D₂ away from the top surface 102 of the liquefied portion 104 of chemical 124.

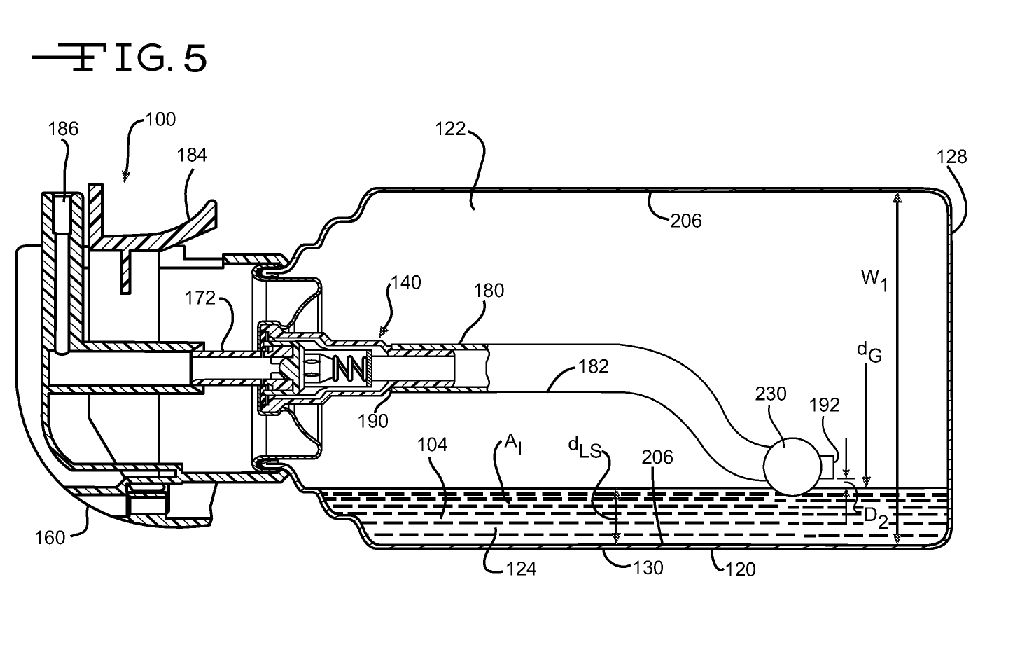

Referring to FIG. 5, in one embodiment, the storage chamber 122 has a width W₁ measured from one side of the inner surface 206 of the sidewall 130 to an opposing side of the inner surface 206 of the sidewall 130. The liquefied portion 104 of chemical 124 when the storage chamber 122 is in a sideways position, a position in which the aerosol spray can 100 is generally perpendicular to the direction of gravity within ±5 degrees, has a depth of d_{LS}, as measured from the top surface 102 to the inner surface 206. The flotation device 230 is connected to the extension tube 180 and floats on the liquefied portion 104 when in a sideways position, helping insure that the second end 192 of the extension tube 180 remains a distance D₂ away from top surface 102 of the liquefied portion 104 of chemical 124.

Preferably, in the upright position, the second end 192 of the extension tube 180 is a distance D₂ away from the top surface 102 of chemical 124, so that no portion of the extension tube 180 is in contact with the chemical 124 when in the upright position. Additionally, when in an upside down position, a position in which the aerosol spray can 100 is generally parallel to and opposite the direction of gravity within ±5 degrees, the second end 192 of the extension tube 180 is a distance D₂ away from the top surface 102 of the chemical 124. In the upside down position, it is possible that a portion of the extension tube 180, or the valve assembly 140, is in contact with a liquefied portion 104 of the chemical 124. Finally, when in a sideways position, the extension tube 180 is a distance D₂ away from the top surface 102 of the chemical 124, so that no portion of the extension tube 180 is in contact with the chemical 124 when in the sideways position. Distance D₂ may vary when going between an upright position, an upside down position, and a sideways position.

Referring to FIG. 3, in one embodiment, the liquid portion 104 of chemical 124 exerts a buoyant force F_{b} on the flotation device 230 and the portion of extension tube 180 which is immersed in the liquid portion 104. Additionally, gravity exerts a gravitational force F_{g} on the flotation device 230 and the portion of extension tube 180 which is immersed in the liquid portion 104. In order for the floatation device 230 to float on the liquid portion 104, the buoyant force F_{b} must be greater than or equal to the gravitational force F_{g}. The buoyancy force F_{b} is equal to the magnitude of the weight of liquid portion 104 displaced by the flotation device 230 and the portion of extension tube 180 which is immersed in the liquid portion 104. The gravitational force F_{g} is equal to the magnitude of the weight of the flotation device 230 and the weight of the portion of extension tube 180 which is immersed in the liquid portion 104.

During assembly of the aerosol spray can 100, chemical 124 in a liquid form may be filled into the housing 120 either before or after the mounting cup 136 is installed to close off the opening in the upper wall 126 of the housing 120. Subsequently, in addition to chemical 124, a propellant gas, such as CO₂ or HFC-152a, which may be slightly soluble in the chemical 124, may be forced into the storage chamber 122 by means of a filling head forcing the propellant gas into space above the chemical 124.

In one embodiment, during assembly of the aerosol spray 100, the storage chamber 122 is first filled with an initial amount A_{I} of chemical 124, where a liquefied portion 104 of the chemical 124 forms top surface 102, and where the general direction of the top surface 102 is perpendicular to the direction of gravity d_{G}. Either before or after filling the storage chamber with an initial amount A_{I} of chemical 124, the mounting cup 136 is installed over the storage chamber 122, sealing the storage chamber 122. The mounting cup 136 is connected with the extension tube 180 which extends into the storage chamber 122. The extension tube 180 is connected with the mounting cup 136 at the first end 190 and extends into the storage chamber 122 at the second end 192. By connecting the flotation device 230 with the extension tube 180, one can insure that the second end 192 of the extension tube 180 remains a distance D₂ away from the top surface 102 of the liquefied portion 104 of the chemical 124 regardless of the position of the aerosol spray can 100.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. An aerosol spray can comprising:
a housing forming a storage chamber;
an initial amount of a chemical within the storage chamber in both liquid and gaseous states, wherein the chemical in a liquid state forms a top surface above which there is the chemical in a gaseous state;
a valve assembly attached to the housing, the valve assembly including a stem forming a central passage through which the chemical dispenses from the storage chamber;
an extension tube connected with the valve assembly at a first end and extending into the storage chamber at a second end, wherein the second end of the extension tube forms an opening through which the chemical enters the extension tube; and
a flotation device connected with the extension tube, wherein an average density of the flotation device is equal to or less than an average density of the chemical in a liquid state.

2. The aerosol spray can of claim 1, wherein the flotation device maintains the opening of the extension tube above the top surface.

3. The aerosol spray can of claim 1, wherein the floatation device is located at or within five centimeters of the second end of the extension tube.

4. The aerosol spray can of claim 1, wherein the flotation device surrounds the extension tube.

5. The aerosol spray can of claim 1, wherein the extension tube comprises silicone.

6. The aerosol spray can of claim 1, wherein the second end of the extension tube is a distance away from the top surface of the chemical in a liquid state.

7. An aerosol spray can comprising:
a housing;
an initial amount of a chemical within the housing in both liquid and gaseous states, wherein the chemical in a liquid state forms a top surface above which there is the chemical in a gaseous state;
a valve assembly attached to the housing;
an extension tube connected with the valve assembly at a first end and extending into the housing at a second end, wherein the second end of the extension tube forms an opening; and
a flotation device connected with the extension tube, wherein the flotation device floats on the chemical in a liquid state.

8. The aerosol spray can of claim 7, wherein the chemical in a liquid state exerts a buoyant force F_{b} on the flotation device, wherein gravity exerts a gravitational force F_{g} on the flotation device, and wherein the buoyant force F_{b} is greater than the gravitational force F_{g}.

9. The aerosol spray can of claim 7, wherein in an upright position the second end of the extension tube is a distance away from the top surface of the initial amount of chemical, and wherein no portion of the extension tube is in contact with the initial amount of chemical.

10. The aerosol spray can of claim 7, wherein in an upside down position the second end of the extension tube is a distance away from the top surface of the initial amount of chemical, and wherein a portion of the extension tube or the valve assembly is in contact with the initial amount of chemical.

11. The aerosol spray can of claim 7, wherein in a sideways position the extension tube is a distance away from the top surface of the initial amount of chemical.

12. The aerosol spray can of claim 7, wherein the floatation device is located at or within five centimeters of the second end of the extension tube.

13. The aerosol spray can of claim 7, wherein the flotation device surrounds the extension tube.

14. An aerosol spray can comprising:
a housing for storing a chemical in a compressed liquid state;
a valve assembly attached to the housing, wherein the valve assembly prevents chemical from exiting the housing unless the valve assembly is activated;
an extension tube connected with the valve assembly at a first end and extending into the storage chamber at a second end; and
a flotation device connected with the extension tube.

15. The aerosol spray can of claim 14 further comprising an initial amount of a chemical within the housing in both liquid and gaseous states, wherein the chemical in a liquid state forms a top surface above which there is the chemical in a gaseous state, wherein the chemical in a liquid state exerts a buoyant force F_{b} on the flotation device, wherein gravity exerts a gravitational force F_{g} on the flotation device, and wherein the buoyant force F_{b} is greater than the gravitational force F_{g}.

16. The aerosol spray can of claim 15, wherein in any position the second end of the extension tube is a distance away from the top surface of the initial amount of chemical.

17. The aerosol spray can of claim 14, wherein the floatation device is located at or within five centimeters of the second end of the extension tube.

18. The aerosol spray can of claim 14, wherein the flotation device surrounds the second end of the extension tube.

19. The aerosol spray can of claim 14, wherein the extension tube comprises a flexible material.

20. The aerosol can of claim 14, wherein an average density of the flotation device is equal to or less than an average density of the chemical in the compressed liquid state.
